(19) United States
(12) Patent Application Publication
(10) Pub. No.: US 2016/0012491 A1
(43) Pub. Date: Jan. 14, 2016

(54) METHODS AND SYSTEMS OF A GIFT-GIVING SERVICE

(71) Applicant: Darshan Ravindra Shah, Malibu, CA (US)

(72) Inventor: Darshan Ravindra Shah, Malibu, CA (US)

(21) Appl. No.: 14/550,341

(22) Filed: Nov. 21, 2014

Related U.S. Application Data
(60) Provisional application No. 62/022,199, filed on Jul. 8, 2014.

(51) Int. Cl. G06Q 30/02; G06Q 50/00

(52) U.S. Cl. CPC G06Q 30/0269; G06Q 30/0261; G06Q 30/0267; G06Q 50/01

(57) ABSTRACT

In one exemplary aspect, a method of an online gift-giving service includes the step of obtaining a set of social relationships between a giver and a set of receivers. A step includes determining a relationship category for each relationship in the set of social relationships. A step includes generating a profile for each receiver in the set of receivers. A step includes determining a set of gift giving dates for each receiver in the set of receivers based on the attributes of each receiver. A step includes determining a set of gift giving ideas for each gift giving date. Optionally, a step include communicating the set of gift giving dates for each receiver and the set of gift giving ideas for each gift giving date to the giver.

### CROSS-REFERENCE TO RELATED APPLICATIONS

This application claims priority to U.S. provisional patent application No. 62/022,199, titled METHODS AND SYSTEMS OF A GIFT-GIVING SERVICE, and filed on Jul. 8, 2014. This application is incorporated herein by reference.

### BACKGROUND

1. Field

This application relates generally to computerized analytics and optimization services, and more specifically to a system, article of manufacture and method of a computerized gift-giving service.

2. Related Art

Traditionally, gift givers may visit stores and browse items on display. The gift givers may peruse several stores and many items before deciding on a gift for a particular receiver. This process can be time consuming. Additionally, other factors, such as gift giver time constraints, knowledge of the receiver's attributes, location, etc., can limit the range of possible items that may be selected as a gift.

Moreover, many givers can often forget about upcoming gift giving occasions. Tracking gift giving occasions across an age and/or ethnically diverse population of receivers can be difficult and time consuming. Accordingly, gift givers may benefits from a system that reminds them about upcoming gift giving occasions.

### BRIEF SUMMARY OF THE INVENTION

In one aspect, a method of an online gift-giving service includes the step of obtaining a set of social relationships between a giver and a set of receivers. A step includes determining a relationship category for each relationship in the set of social relationships. A step includes generating a profile for each receiver in the set of receivers. A step includes determining a set of gift giving dates for each receiver in the set of receivers based on the attributes of each receiver. A step includes determining a set of gift giving ideas for each gift giving date.

Optionally, a step include communicating the set of gift giving dates for each receiver and the set of gift giving ideas for each gift giving date to the giver. The set of gift giving dates for each receiver and the set of gift giving ideas for each gift giving date are communicated to a giver's mobile device. With a merchant's proximity device system, a proximity of the giver's mobile device can be detected. A potential gift ideas can be communicated to a giver's mobile device based on a giver's location, a time of day or an implied giver activity. The merchant's proximity device system comprises an iBeacon system.

### BRIEF DESCRIPTION OF THE DRAWINGS

FIG. 1 illustrates an example computerized method for suggesting gifts, according to some embodiments.

FIG. 2 an example computerized system for managing a giver's gift ideas, according to some embodiments.

FIG. 3 illustrates, in block diagram format, an example gifting services server, according to some embodiments.

FIG. 4 is a block diagram of a sample computing environment that can be utilized to implement various embodiments.

FIG. 5 depicts computing system with a number of components that may be used to perform any of the processes described herein.

FIG. 6 depicts an example process for building a receiver profile, according to some embodiments.

The Figures described above are a representative set, and are not an exhaustive with respect to embodying the invention.

### DESCRIPTION

Disclosed are a system, method, and article of manufacture of remote digital acquisition and/or other services. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein in, use of terms such as ‘current’, ‘real time’ and/or other similar synonyms assume various latencies such as networking and/or processing latencies.

### Definitions

Context awareness can refer to the idea that computers can both sense, and react based on their environment.

Gift an item and or service given to someone without the expectation of payment.

Giver can be an entity (e.g. a person, a corporation, an educational institution, etc.) seeks to and/or transfer of something without the expectation of receiving something in return.

iBeacon® can be an indoor proximity system that enables an iOS device or other hardware to send push notifications to iOS devices in close proximity. It is noted that other types of proximity systems can be utilized in lieu of an iBeacon. Said proximity systems can be configured for other mobile device operating systems such as Android®, Windows Phone®, and the like. Proximity systems can use Bluetooth low energy proximity sensing to transmit a universally unique identifier picked up by a compatible application and/or operating system (e.g. in a user mobile device) that can be turned into a physical location or trigger an action on the device such as a check-in on social media and/or a push notification.

Like button can be a feature in social networking services, Internet forums, news websites and/or online blogs. A user can express that he/she likes, enjoys or supports certain content by interacting with a like button in a specified manner (e.g. by virtually ‘pushing’ it with a mouse pointer).

Machine learning can be a subfield of computer science and statistics that constructs and studies of systems that can learn from data (e.g. as opposed to only explicitly programmed instructions).

Mobile device can include a handheld computing device that includes an operating system (OS), and can run various types of application software, known as apps. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD) (e.g. Google Glass®), virtual reality head-mounted display, smart watches, other wearable computing systems, etc.

Online social network service can be a platform to build social networks or social relations among people who for example, share interests, activities, backgrounds or real-life connections. A social network service can consists of a representation of each user (e.g. a profile, an avatar, etc.), his/her social links, and a variety of additional services. Social networking can include web-based services that allow individuals to create a public profile, to create a list of users with whom to share connection, and view and cross the connections within the system.

Receiver can be an entity that receives a gift.

Social network can be a social structure made up of a set of social actors (such as individuals or organizations) and a set of the dyadic ties between these actors (e.g. a social relationship between two individuals such as a giver and a receiver).

### Exemplary Method

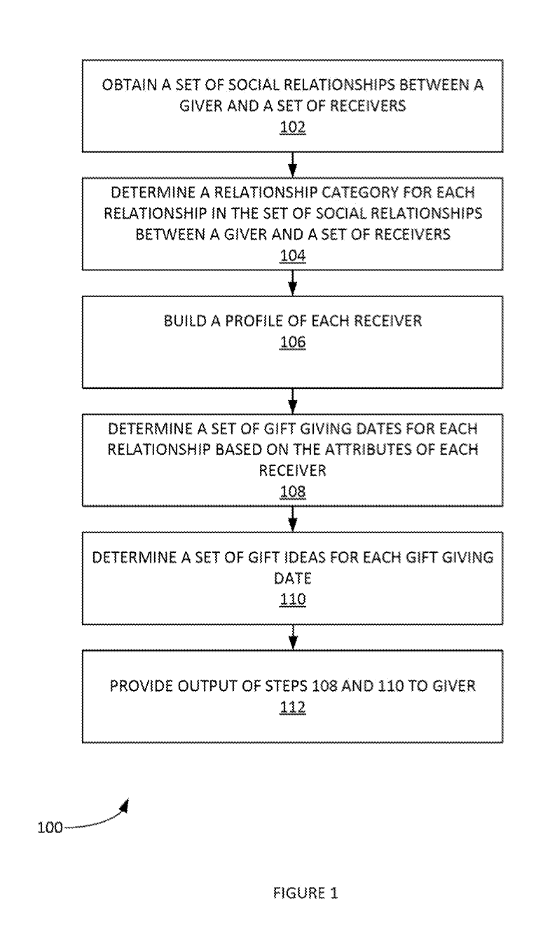

FIG. 1 illustrates an example computerized process 100 for suggesting gifts, according to some embodiments. In step 102 of process 100, a set of social relationships can be obtained between a giver and a set of receivers. A giver can provide a list of contacts/friends on an online social network. For example, a system implementing process 100 can be provided access to an explicit and/or implicit social graph (in whole and/or in part) managed by an online social network provider (e.g. Facebook®, Twitter®, LinkedIn®, etc.). A user of an online social network gram access to his/her online social network relationship. In another example, a giver can upload a list of receivers. Receivers can be implicitly determined based on an analysis of a giver's behaviours. For example, both giver and receiver meet for lunch once a week as determined from the giver's mobile device calendaring system.

In step 104, a relationship category (e.g. familial, professional, social, religious, implicit, etc.) for each relationship in the set of social relationships can be determined. For example, the set of relationships can be explicitly defined in an online social network profile of the giver and/or the receiver. For example, a receiver's Facebook® profile can define her relationship with a giver as the giver's wife. In another example, the relationship can be inferred based on information obtained from the social network. For example, names and ‘places lived’ information can be used to infer familial relationships. The content of electronic messages can be used to infer a relationship type as well. A user may have emailed another person regularly on Mother's Day with one-email stating ‘You are the best mom ever’. This information can be used to infer that the sender is a son/daughter of the receiver. In yet another example, a system implementing process 100 can query users (e.g. via an email with a fillable form, text message, social network message, etc.) about their relationships. It is noted that other methods of determining user relationships can be used. These methods are provided by way of example and not of limitation. Relationships between givers and receivers can have specified attributes (e.g. boss/employee; parent/child/, friendship, romantic, etc.).

In some examples, a social relationship can be, inter alia: an explicit online social relationship (e.g. a follower, an online social network friend, such as a friend on Facebook®, a relative, a social contact, etc.); an implicit social graph connection, etc. As used herein, an implicit social graph can be a social network that is constructed by the interactions between users and their groups. Various social network analysis techniques can be utilized (e.g. to identify local and global patterns, locate influential entities, and examine network dynamics). Example social network analysis techniques can include, inter alia, micro level, meso level and/or macro level analysis techniques of a social network that includes the giver and/or various receivers. Social network analysis can be utilized to automatically determine a value of an interpersonal relationship between a giver and one or more receivers. The interpersonal relationship value can be utilized to determine appropriate gift values and/or gift-giving occasions. For example, an online social network's relationship status fields can be analyzed to determine a relationship state of the receiver and a giver. A relationship status weight can be based on the type of relationship and/or other factors such as length of said relationship. In some examples, a server-side functionality (e.g. gifting services server 204 infra) that implemented process 100 can automatically query an application programming interface (API) of an online social network to obtain this information.

In step 106, a profile of each receiver in the set of receivers can be built and maintained. For example, the information in a receiver's online social network(s) can be mined for profile information. Receivers can be provided queries, forms and/or tests that provide receiver attributes. Profile information can include demographic data, explicit user preference data such as ‘likes’ (e.g. using a like button on a website), reposting online content to a social network page, content analysis of a user's social networking posts, microblog posts, etc. A user's web browsing history can be used to develop a user's profile. A user's purchasing history (e.g. in an e-commerce web site such as Amazon.com®) can be used to develop a user's profile. Other analytics and/or information gathering techniques can be utilized to obtain information about a user (e.g. a giver and/or a receiver). It is further noted that a profile can be built and maintained for the giver as well in some embodiments.

In step 108, a set of gift giving dates (e.g. giving occasions, etc.) can be determined for each receiver in the set of receivers based on the attributes of each receiver. For example, a receiver can have certain demographic attributes that can be associated with specified holidays and/or a role of said receiver in the specified holiday vis-à-vis the giver. For example, a receiver can be a spouse of the giver and the specified holiday can be St. Valentine's Day. Each gift giving date can also have its own attributes (e.g. religious holiday, romantic holiday, professional holiday, patriotic holiday, expensive gifts not normally given, a birthday, romantic gifts are appropriate, food-related gifts are the social norm, etc.).

In step 110, a set of gift giving ideas for each gift giving date can be determined. Returning to the St. Valentine's Day, it can be determined that if the relationship between a giver and the receiver is romantic in nature (e.g. spousal, dating for over three months, etc.). The receiver's profile attributes can then be matched with a set of gift giving idea that intersect with both the ‘romantic in nature’ category and the ‘warned by this receiver’ category. Additional ranking and/or sorting algorithms can be applied to further refine the set of gift giving ideas. For example gift with the most attributes mapped to receiver attributes can be ranked higher. In some examples, gift occasion attributes can also be mapped to gifts and/or receiver profiles to further weight the gift giving idea sorted list. See infra for additional exemplary sampling and/or machine learning algorithms.

In step 112, the output of steps of 108 and/or 110 can be provided to the giver. For example, process 100 can be implemented with a gift giving application operating in the giver's mobile device (e.g. a smart phone, smart glasses, tablet computer, smart watch, other wearable computing system, etc.). The output can be pushed to the gift giving application. In other examples, the output can be communicate to the giver via text message, email, social network message, augmented-reality message, etc. In yet another example, proximity location systems can detect that the user (e.g. via the user's mobile device) is in a location associated with a particular gift idea with an upcoming date. The user can be notified that a gift is available in a nearby store. Additionally, various motivating mechanisms can be provided to the giver including, inter alia: digital coupons, quotes from the receiver, digital images of the receivers, digital videos of the receiver and the giver, and the like.

Process 100 can implement various machine learning and/or optimization techniques to improve said gift giving services. Example optimization techniques can include a stochastic gradient algorithms, other gradient algorithms, evolutionary algorithms, combinatorial optimization algorithms, etc. Example machine learning algorithms can include, inter alia: supervised learning algorithms; unsupervised learning algorithms; semi-supervised learning; transductive inference; reinforcement learning; developmental learning, decision tree learning; association rule learning; artificial neural networks; support vector machines; clustering; etc.

### Exemplary Computer Architecture and Systems

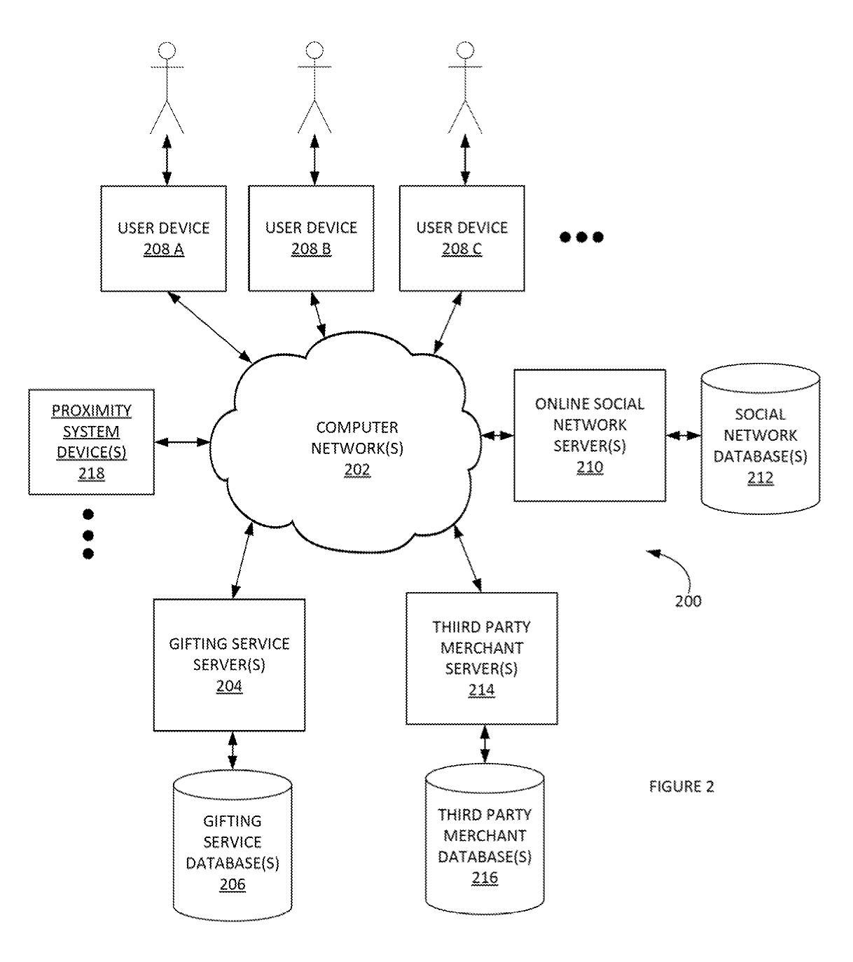

FIG. 2 an example computerized system 200 for managing as giver's gift ideas, according to some embodiments. System 200 can include computer network(s) 202. Computer network(s) 202 can include the Internet, local area networks, enterprise networks, wide area networks, digital cellular networks. Wi-Fi networks, etc. A gifting service server 204 can implement various algorithmic gift identification and suggestion services (e.g. process 100). Gifting services server 204 can include functionalities for obtaining a list of receivers for a particular giver. Gifting services server 204 can determine an appropriate set of gifts for each receiver. Gifting services server 204 can interact with other information sources such as online social network server 210, third-party merchants server 214, user mobile device(s) 206 A-B and the like. In this way gifting services server 204 can obtain information use to build and/or manage a profile for each receiver. Gifting services server 204 can build and/or manage a profile for each potential gift item. Gifting services server 204 can build and/or manage a profile for each giver. Gifting services server 204 can build and/or manage a profile for gifting occasions (e.g. holidays, anniversaries, birth days, accomplishment dates, etc.). Gifting services server 204 can include modules for monitoring a user (e.g. a giver and/or a receiver) to determine appropriate gifting occasions. For example, gifting services server 204 can include modules for monitoring a user's online social network profiles (e.g. to determine a birthday, graduation day, purchase of a new home, promotion at work, etc.), calendaring systems, and the like. Gifting services server 204 can include functionalities for interacting with a proximity device system (e.g. implemented proximity devices 218. For example, a merchant can implement an iBeacon system. The merchant's server can communicate to and/or receive instructions/information from gifting services server 204. In this way, iBeacon devices can communicate potential gift ideas to a giver's mobile device based on such factors as the giver's location, time of day, implied activity and the like. Information used by gifting services server 204 can be stored in gifting services database(s) 206. Gifting services server 204 can include web servers, search engines, database managers, location-based services functionalities, text messaging and/or emailing modules, etc.

Online social network's server 210 can manage an online social work website. Online social network's server 210 can perform various analytics of the online social network and/or provide information to other entities (e.g. gifting services server 204) about the online social network analytics. Information used by online social network's server 210 can be stored in online social network database(s) 216. Third-party merchant's server 214 can provide user purchasing history, gift attribute information and/or gift purchase location information to gifting services server 204. Information used by third-party merchant's server 214 can be stored in third-party merchant's database(s) 216.

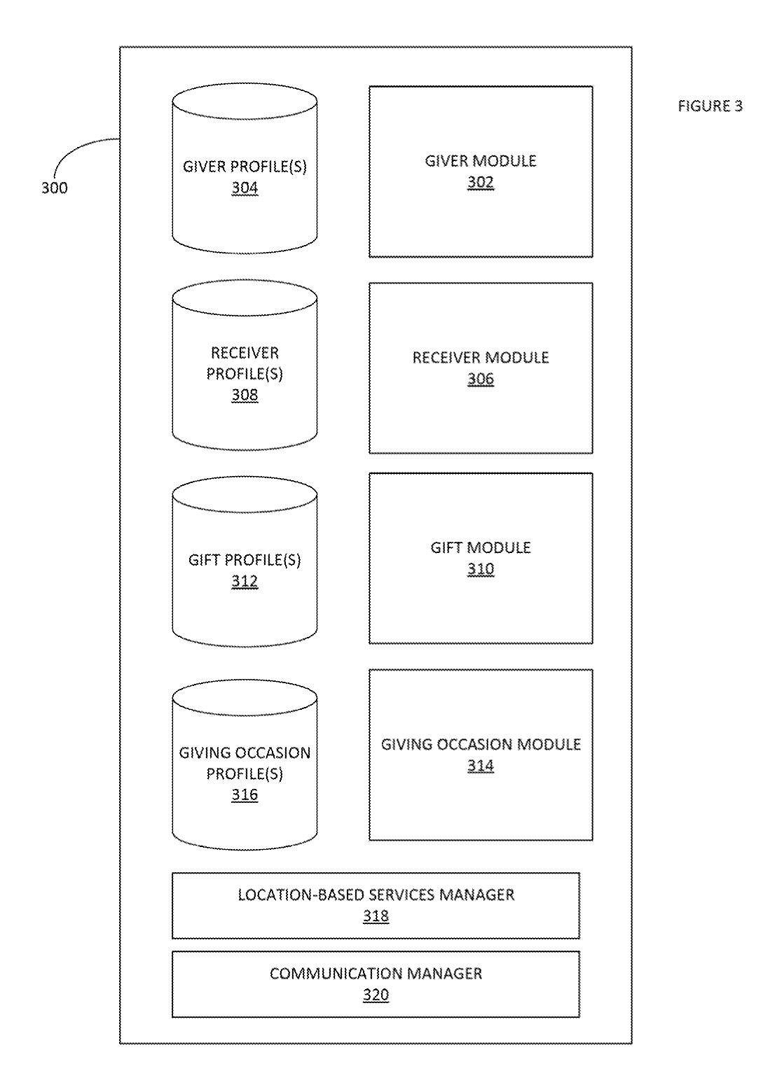

FIG. 3 illustrates, in block diagram format, an example gifting services server 300, according to some embodiments. Giver module 302 can build and maintain a giver profile. The giver profile can include a set of receivers for whom the giver would like to obtain gifts. The giver profile can include giver demographic attributes, social network behavior history (e.g. what the giver has ‘liked’), purchasing history, receiver request history, etc. The giver profile can also include a set of receivers already explicitly linked with the giver. The giver profile can include a history of gifts purchased by the giver and which receivers received said gifts. Giver module 302 can search a giver's social network and/or email contacts (as well as other contacts) and provide suggested lists of receivers to a giver. Giver module 302 can perform other giver-related methods provided herein. Giver profiles can be stored in giver profiles data-base 304. Giver module 302 can sort a list of gifts based on giver profiles/attributes, receiver profiles/attributes, gift profiles/attributes and/or giving occasion profiles/attributes. Giver module 302 can map a sorted list of gifts for each receiver in a list of receivers associated with a giver.

Receiver module 306 can build and maintain a receiver profile. The receiver profile can include a set of givers associated with each receiver. The receiver profile can include receiver demographic attributes, social network behavior history (e.g. what the receiver has ‘liked’), purchasing history, receiver request history, etc. The receiver profile can also include a set of givers already explicitly linked with the receiver. The giver profile can include a history of gifts received by the receiver and which giver provided said gifts. In this way, the can notify potential givers not obtain redundant gifts. Receiver module 306 can search a receiver's social network and/or email contacts (as well as other contacts) and provide suggested lists of others receivers to a giver already associated with the receiver. Receiver module 306 can obtain receiver interests information can provide gift recommendations to giver module 302. Receiver module 306 can use an application in a receiver's mobile device to track a receiver's locations over a period of time. The locations can be matched to retail establishments. Receiver module 306 can track a receiver's purchase history and generate a profile of items/goods/services that are of interest to the receiver. Receiver module 306 can track a receiver's social networking likes and generate a profile of subjects/content explicitly liked by the receiver. Receiver module 306 can perform other tasks to determine a receiver's topics of interest. In this way, receiver module 306 can provide gift ideas to giver module 302. Receiver module 306 can perform other receiver-related methods provided herein. Receiver profiles can be stored in receiver profiles database 308. Receiver module 306 can place plugin programs into a receiver's mobile device and/or other computing device in order to track user behavior (e.g. like buttons selected, web browsing history, purchase history, status updates, etc.).

Gift module 310 can build and maintain a gift profile. Gift profiles can be generated from gift attributes (e.g. cost, location, maker, quality ratings, safety ratings, type, etc.). Gift profiles can be stored in gift profiles database 312. Gift occasions module 316 can build and maintain a gift occasions profile. Gift occasions profiles can be generated from gift occasions attributes (e.g. dates, holiday type, holiday origin, religious affiliations, gift types associated with the holiday, personal achievements, anniversaries, etc.). Gift occasions profiles can be stored in gift occasions profiles database 316.

Location-based services manager 318 can manage location-based services performed by the gifting services server 300. For example, location-based services manager 318 can detect iBeacons nearby user device. Location-based services manager 318 can leverage iBeacon services to provide notifications (e.g. a push notification) about selected recipient gifts to the user's mobile device. Communication manager 320 can interact with application programming interfaces (API) of other entities (e.g., an Amazon.com API, a Facebook API, a Twitter API, etc.) to obtain information required by the other elements of the gifting services server 300. Communication manager 320 can interact mobile-side client applications. Communication manager 320 can interact with proximity systems (e.g. via another entity server that manages the proximity system). Communication manager 320 can obtain information from the other modules of and compose natural languages messages emails, text messages, push notifications, augmented-reality messages, etc.) to users. Accordingly, communication manager 320 can include various human language Natural Language Generation (NLG) functionalities and/or human-language translations functionalities. Communication manager 320 can also implement various context awareness methods for matching context/location gift opportunities with a user's current context (assuming processing and/or networking latencies).

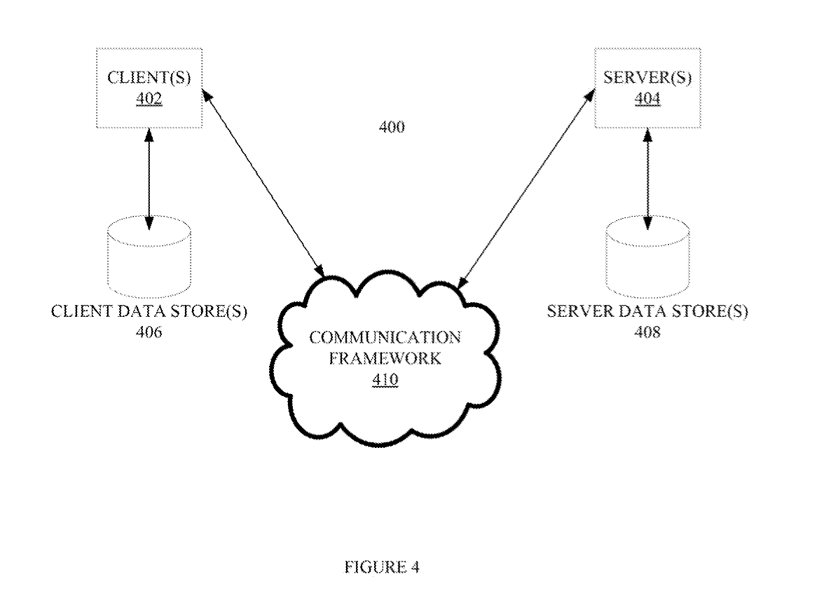

FIG. 4 is a block diagram of a sample computing environment 400 that can be utilized to implement various embodiments. The system 400 further illustrates a system that includes one or more client(s) 402. The client(s) 402 can be hardware and/or software (e.g., threads, processes, computing, devices). The system 400 also includes one or more server(s) 404. The server(s) 404 can also be hardware and/or software (e.g., threads, processes, computing devices). One possible communication between a client 402 and a server 404 may be in the form of a data packet adapted to be transmitted between two or more computer processes. The system 400 includes a communication framework 410 that can be employed to facilitate communications between the client(s) 402 and the server(s) 404. The client(s) 402 are connected to one or more client data store(s) 406 that can be employed to store information local to the client(s) 402. Similarly, the server(s) 404 are connected to one or more server data store(s) 408 that can be employed to store information local to the server(s) 404. In some embodiments, system 400 can instead be a collection of remote computing services constituting a cloud-computing platform.

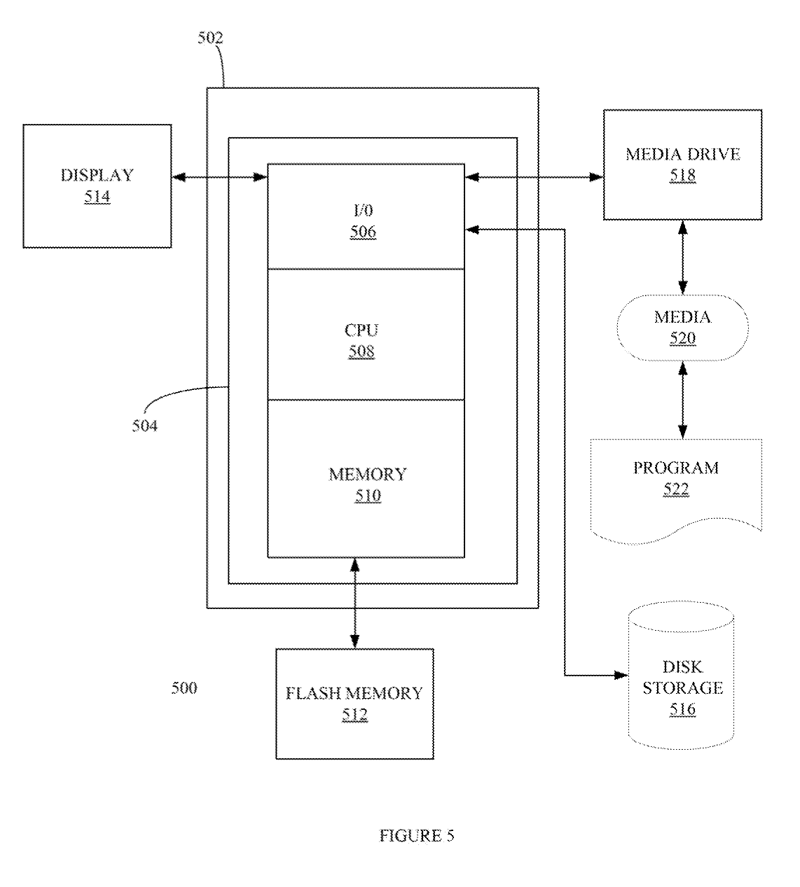

FIG. 5 depicts an exemplary computing system 500 that can be configured to perform any one of the processes provided herein. In this context, computing system 500 may include, for example, a processor, memory, storage, and I/O devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform any of the processes described herein. The main system 502 includes a motherboard 504 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 518 can read/write a computer-readable medium 520, which can contain programs 522 and/or data. Computing system 500 can include a web browser. Moreover, it is noted that computing system 500 can be configured to include additional systems in order to fulfill various functionalities. Computing system 500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

It is noted that databases with user information can be automatically sampled by the statistical algorithm. There are several methods which may be used to select a proper sample size and/or use a given sample to make statements (within a range of accuracy determined by the sample size) about a specified population. These methods may include, for example:

1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.

2. Bayesian Analysis as, for example, in “Bayesian Data Analysis” by A Gelman, I. B. Carlin, H. S. Stern and D. B. Rubin, Chapman and Hall 1995; Chapter 7, where several sampling designs are discussed.

3. Artificial intelligence techniques, or other such techniques as Expert Systems or Neural Networks as, for example, in “Expert Systems: Principles and Programming” by Giarrantano and G. Riley, PWS Publishing 1994; Chapter 4, or “Practical Neural Networks Recipes in C++” by T. Masters, Academic Press 1993; Chapters 15,16,19 and 20, where population models are developed from acquired data samples.

4. Latent Dirichlet Allocation, Journal of Machine Learning Research 3 (2003) 993-1022, by David M. Biel, Computer Science Division, University of California, Berkeley, Calif. 94720, USA, Andrew Y. Ng, Computer Science Department, Stanford University, Stanford, Calif. 94305, USA

A Maximum Entropy Model for Part-Of-Speech Tagging, Adwait Ratnaparkhi, University of Pennsylvania, Dept. of Computer and Information Science

It is noted that these statistical and probabilistic methodologies are for exemplary purposes and other statistical methodologies can be utilized and/or combined in various embodiments. These statistical methodologies can be utilized elsewhere, in whole or in part, when appropriate as well.

### Additional Example Method(s)

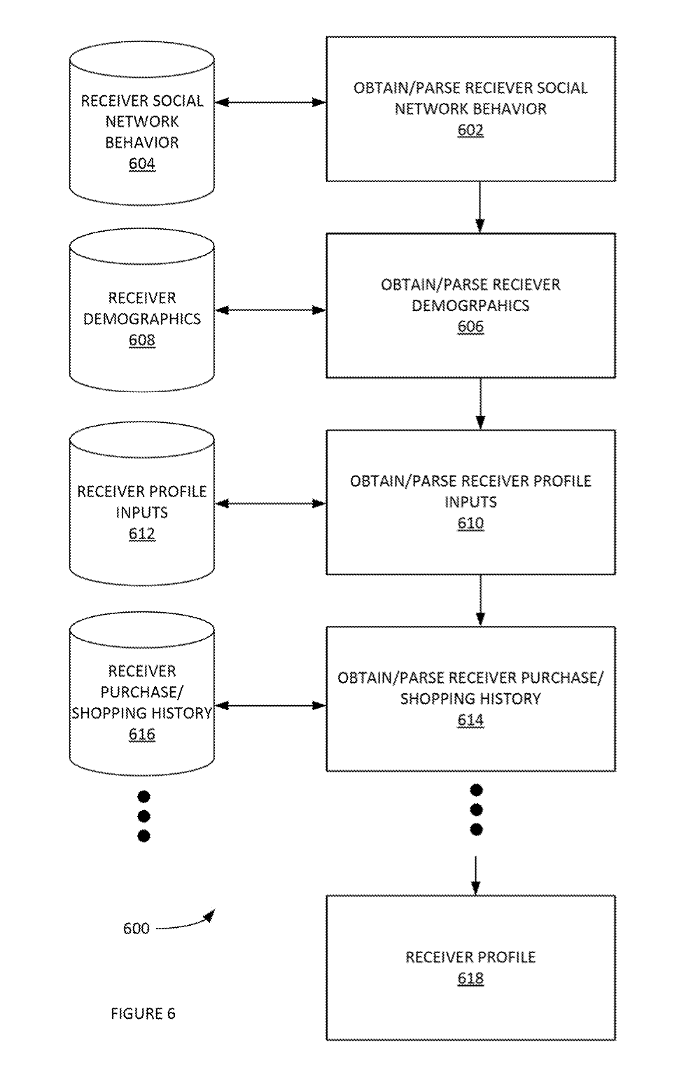

FIG. 6 depicts an example process 600 for building a receiver profile, according to some embodiments. In step 602, receiver social network behaviour can be obtained and/or parsed. Receiver social network data can be obtained from receiver social network behaviour database 604. Example receiver social network behaviour includes likes of celebrities, products, sports teams, musicians, music categories, etc. Example receiver social network behaviour can also include social network status update content, comment content, and the like. For example, a receiver can ‘like’ a Facebook Los Angeles Lakers page. Accordingly, the user's profile can be updated to show the attribute ‘fan of the Los Angeles Lakers’. Gifts involving the Los Angeles Lakers (e.g. clothing with team logos, game tickets, etc.) can then be suggested to a giver.

In step 606, receiver demographics can be obtained and/or parsed. Receiver demographic data can be obtained from receiver demographic database 608. Receiver demographic data can include age, ethnicity, national origin, religion, geographic locations lived in past, salary, profession, education level, etc. For example, a receiver may be from Iran. A giver can be notified that Iranians often receive gifts for the No Ruz holiday.

In step 610, receiver profile inputs can be obtained and/or parsed. Receiver profile inputs data can be obtained from receiver profile inputs database 612. Receiver profile inputs data can include any information provided by the receiver via a web page and/or mobile application interface) when the receiver joins a system implementing process 600. For example, the receiver can indicate that she likes gifts certificates from Starbucks®.

In step 614, receiver purchase/shopping history can be obtained and/or parsed. Receiver purchase/shopping history data can be obtained from receiver purchase/shopping history database 616. Receiver purchase/shopping history data can include any information provided by the receiver (e.g. via a web page and/or mobile application interface) and/or a third-party retailer (or other purchase/shopping history aggregator entity). For example, the receiver can coffee from Starbucks on a regular basis. This information can be included in the receiver's profile.

Each step of process 600 can be used to refine the receiver's profile 618 and ultimately the type of suggested gift and time/occasion to deliver said gift. Each step of process 800 can be associated with a specified weighting factor and/or other optimization technique coefficients. Additionally, it is noted that various optimization techniques (e.g. a stochastic gradient algorithms, other gradient algorithms, evolutionary algorithms, combinatorial optimization algorithms, etc.) can be combined with process 600.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of an online gift-giving service comprising:
obtaining a set of social relationships between a giver and a set of receivers;
determining a relationship category for each relationship in the set of social relationships;
generating a profile for each receiver in the set of receivers:
determining a set of gift giving dates for each receiver in the set of receivers based on at least one attribute of each receiver; and
determining a set of gift giving ideas for each gif giving date.

2. The method of claim 1 further comprising:
communicating the set of gift giving dates for each receiver and the set of gift giving ideas for each gift giving date to the giver.

3. The method of claim 2, wherein the set of gift giving dates for each receiver and the set of gift giving ideas for each gift giving date are communicated to a giver's mobile device.

4. The method of claim 3, wherein the relationship category comprises a familial relationship, a professional relationship, social relationship or a religious relationship.

5. The method of claim 4, wherein the relationship category comprises an implicit social relationship derived from a giver's online social networking profile and a receiver's online social networking profile.

6. The method of claim 5, wherein the gift giving dates comprises a gifting-giving holiday.

7. The method of claim 6, wherein the attributes of each receiver are derived from each receiver's online social networking profile.

8. The method of claim 7, further comprising:
detecting, with a merchant's proximity device system, a proximity of the giver's mobile device.

9. The method of claim 8, further comprising:
communicating a potential gift ideas to a giver's mobile device based on a giver's location, a time of day or an implied giver activity.

10. The method of claim 9, wherein the merchant's proximity device system comprises an iBeacon system.

11. A computerized system of an online gift-giving service comprising:
a processor configured to execute instructions;
a memory containing instructions when executed on the processor, causes the processor to perform operations that:
obtain a set of social relationships between a giver and a set of receivers;
determine a relationship category for each relationship in the set of social relationships;
generate a profile for each receiver in the set of receivers;
determine a set of gift giving dates for each receiver in the set of receivers based on an attribute of each receiver; and
determine a set of gift giving ideas for each gift giving date

12. The computerized system of claim 11, wherein memory containing instructions when executed on the processor, further causes the processor to perform operations that:
communicating the set of gift giving dates for each receiver and the set of gift giving ideas for each gift giving date to the giver, wherein the set of gift giving dates for each receiver and the set of gift giving ideas for each gift giving date are communicated to a giver's mobile device.

13. The computerized system of claim 12, wherein memory containing instructions when executed on the processor, further causes the processor to perform operations that:
detecting, with a merchant's proximity device system, a proximity of the giver's mobile device.

14. The computerized system of claim 13, wherein memory containing instructions when executed on the processor, further causes the processor to perform operations that:
communicating a potential gift ideas to a giver's mobile device based on a giver's location, a time of day or an implied giver activity.

15. The computerized system of claim 14, wherein the merchant's proximity device system comprises an iBeacon system.

16. The computerized system of claim 15, wherein the set of gift giving, dates for each receiver and the set of gift giving ideas for each gift giving date are communicated to a giver's mobile device.

17. The computerized system of claim 16, wherein the relationship category comprises a familial relationship, a professional relationship, social relationship or a religious relationship.

18. The computerized system of claim 17, wherein the relationship category comprises an implicit social relationship derived from a giver's online social networking profile and a receiver's online social networking profile.

19. A computerized method comprising:
receiving a set of social relationships between a giver and a receiver;
determining a relationship category for the set of social relationships;
generating a gift profile for the receiver, wherein the gift profile comprises a set of gift giving dates for the giver to provide a gift to the receiver based on at least one attribute of the receiver;
determining a set of gift giving ideas for each gift giving date;
determining that a gift giving date is upcoming;
determining that the receiver is within a specified location, wherein the specified location of the receiver is determined when a merchant's proximity device system detects a proximity of a giver's mobile device;
determining that a gift in the set of gift giving ideas is sold by the merchant; and
communicating a gift alert to the giver's mobile device that the gift for the receiver is is sold by the merchant.

20. The computerized method of claim 19, wherein the gift alert comprises a text messaging and comprises information about the receiver, the receiver's attribute, the gift profile, the gift giving idea and the gift giving date.
